(19) United States
(12) Patent Application Publication
(10) Pub. No.: US 2008/0014116 A1
(43) Pub. Date: Jan. 17, 2008

(54) PASSIVE TYPE EMISSION FLUX SAMPLER

(75) Inventors: Yukio YANAGISAWA, Tokyo (JP); Tomio UCHI, Tokyo (JP); Shaobu CAI, Tokyo (JP); Kazukiyo KUMAGAI, Tokyo (JP); Minoru FUJII, Ibaraki (JP)

Correspondence Address: GREENBLUM & BERNSTEIN, P.L.C., 1950 ROLAND CLARKE PLACE, RESTON, VA, 20191, US

(73) Assignees: Yukio YANAGISAWA, Tokyo (JP); IMAI CORPORATION, Okayama (JP)

(21) Appl. No.: 11/779,688

(22) Filed: Jul. 18, 2007

Related U.S. Application Data
(63) Continuation of application No. 10/597,041, filed on Sep. 6, 2006.

(30) Foreign Application Priority Data
Jan. 9, 2004 (JP) JP2004-003930

(51) Int. Cl. G01N 21/78

(52) U.S. Cl. 422/55

(57) ABSTRACT

A passive type emission flux sampler measures an emission flux of a specified chemical sample released from an inspection object. The passive type emission flux sampler includes a hollow casing sealed except for an opening formed at a bottom for taking in a chemical substance. A test specimen that changes color in a reaction with the chemical substance is disposed to an inner surface of the casing opposite the opening. A water retaining material for maintaining the test specimen in a humid condition is disposed in the hollow casing.

The present application is a continuation application of pending U.S. patent application Ser. No. 10/597,041, filed on Jul. 7, 2006, which is the national stage of International Application No. PCT/JP2004/014930, filed on Oct. 8, 2004, which claims the benefit of Japanese Application No. 2004-003930, filed on Jan. 9, 2004, the contents of which are expressly incorporated herein by reference in their entireties.

### TECHNICAL FIELD

The present invention concerns a passive type emission flux sampler capable of simply measuring emission flux of a toxic chemical substance such as formaldehyde emission from an inspection object such as furniture and building materials into air (released amount per unit area and per unit time) with no requirement of power or electric power supply at all, and a flux measuring apparatus which measures the emission flux more correctly by using the sampler.

### BACKGROUND ART

In recent years, many cases have been reported where residents in newly built homes suffer from various physical deconditionings such as headache, sore throat, eye hurt, nasal inflammation, nausea, breathing problem, dizziness dermatitis, etc., which are called as “sick building syndrome” and bring about social problems.

The mechanism of pathogenesis of the sick building syndrome has not yet been analyzed but it may be considered to be attributable mainly to air contamination in a room due to volatilization of noxious chemicals such as formaldehyde or volatile organic compounds (VOC) contained, for example, in building materials, furniture, furnishing goods, carpets, and curtains used in the residences.

By the way, in a case where residents in newly built homes suffer from sick building syndrome, or where room contamination at high concentration, not restricted to the newly built homes, is found, if it can be determined which building material or furniture releases the causal substance, causes for the sick building syndrome can be eliminated by replacing the relevant building material or the furniture.

However, the method of measuring the released amount of the volatile organic chemical substance according to JIS at present is a desiccator method of measuring a test specimen of the building material by putting it into a small-sized desiccator and, while it is an urgent need for preparing a draft for a small-sized chamber method of using a small-sized chamber of 20 to 1000 liter capable of accommodating and measuring building materials, or a large-sized chamber method of using a large-sized chamber capable of accommodating and measuring furniture or building materials for the feature, none of them can measure the emission flux from the building materials assembled to the building.

Further, while apparatus for measuring the concentration of noxious chemical substances contained in air in the room are present, since the measuring apparatus can not measure the emission flux of the noxious chemical substance, the source of release can not be identified.

Accordingly, it has been proposed recently measuring apparatus for the amount of chemical substances released from any place such as walls, ceilings, and floors by attaching an attachment to the concentration measuring apparatus.

[Patent Document 1] JP-A No. 2002-162322.

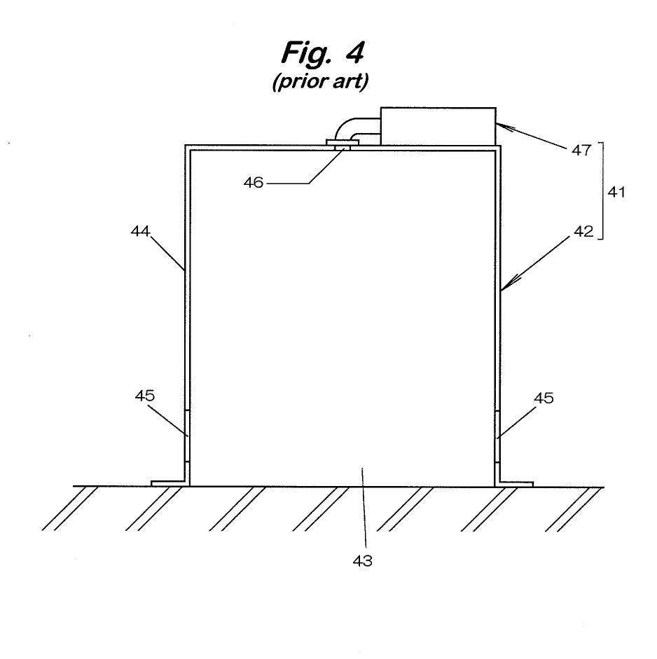

FIG. 4 shows such an existent measuring apparatus 41, in which the bottom of an attachment 42 formed in a box-like configuration is formed as an opening 43, clean air introduction ports 45 provided with filters, etc. are formed on the lateral surfaces 44, and an air exit port 46 is formed at the upper surface, and a concentration measuring apparatus 47 for automatically sucking air and measuring the concentration of chemical substances contained in air is connected with the air exit port 46.

Then, when air is sucked by the concentration measuring apparatus 47 in a state of engaging the opening 43 of the attachment 42 to the site of the inspection object such as a wall surface, ceiling surface or floor surface, noxious chemical substances released from the wall surface, etc. are measured by the concentration measuring apparatus 47.

However, since the box 41 is as large as: length×width×height=20 cm×20 cm×30 cm in the size in relation with the air suction amount of the concentration measuring apparatus 47, it is inconvenient to carry about and expensive as well, so that measurement is conducted usually by a set of the measuring apparatus 41.

Accordingly, it requires a long time survey for identifying the source of release for which indoor measurement at a plurality of points is necessary in the building.

For example, in a case where the source of release of chemical substances in one room, is intended to identify, measurement has to be conducted for at least several sites such as on the wall, ceiling, floor, at the room doors, or in the closet. In this case, since measurement has to be conducted successively by using a set of the measuring apparatus 41 and it needs at least about 30 min for the measurement of one site, in a case where all the rooms are intended to be measured thoroughly in one newly built building, this results in a problem of consuming much time and labor.

Further, since the opening of the attachment 41 is as large as: 20 cm×20 cm, measurement can not be conducted unless the place has a plane at least corresponding to the size and since the height is as large as 30 cm, it involves a problem that the measurement is impossible for the narrowed portion with a structural view point of the building.

In addition, since the attachment 42 is lined with stainless steel at the inside and is heavy, it is extremely difficult to be fixed on the ceiling or wall surface and only the floor surface can be actually measured. In addition, since it has a structure of taking in external air (indoor air) from the clean air introduction port 45 formed on the lateral surface 44, in a case where the indoor air has already been contaminated with chemical substances they can not be removed by the filter but intrude into the attachment, this also results in a problem that the reliability for the result of measurement is low.

Further, the air flowing state on the surface of the site of the inspection-object i.e. wall surface, ceiling surface, floor surface etc., to which the opening 43 is contacted, is different from the usual state, since the measuring method is an active type to suck air automatically from the exit port 46.

That is, since the flow speed of air on the surface of the site for the inspection object is increased more compared with that in the usual state of use, the diffusion mechanism of the noxious chemical substance changes from a rate limiting step of the mass transfer in a gas phase boundary layer near the surface of the inspection object to that inside the inspection object

Accordingly, the method of a passive type which can maintain the gas flow in the usual state during measurement is recently recommended, since the measurement result by this method such as an active type is different from the emission flux in the usual state of use.

### DISCLOSURE OF THE INVENTION

### Subject to be Solved by the Invention

Then, the present invention has a technical subject of providing a passive type emission flux sampler capable of simply and accurately measuring the released flow rate (emission flux) of a chemical substance released from a site to be measured including a floor surface, as well as a ceiling, a wall surface, or even a narrow place, without disturbing the flowing state on the surface of the measuring site.

### Means for Solving the Subject

For solving the subject, a passive type emission flux sampler according to the present invention is adapted to measure a emission flux of a certain chemical substance released from an inspection object into air, in which a hollow casing is sealed except an opening that is formed at a bottom of casing for taking in a chemical substance, a test specimen that takes place color change reaction with the chemical substance under a humid circumstance is disposed to the inner surface of the casing of an opposite side of the opening, and a water retaining material for keeping the test specimen in a humid circumstance is disposed in the hollow casing.

### Effect of the Invention

According to the passive type emission flux sampler of the present invention, when the test specimen is wetted by dropping water into casing and then the bottom surface of the casing is fixed to the inspection site of any inspection object such as wall surface, ceiling surface, or floor surface, since a noxious substance such as formaldehyde or volatile organic compound (VOC), when it is contained in the inspection object, intrudes from the opening into the casing and reaches the test specimen, the test specimen changes the color in accordance with the emission flux (released flow rate) of the noxious substance.

Accordingly, by comparing the color of the test specimen with a color chart formed previously in accordance with the emission flux, the emission flux of the noxious substance from the inspection site can be measured, and the total amount of release discharged from the entire building materials can also be calculated based on the ratio between the opening area of the opening and the area of the entire building material.

In this case, since the emission flux is measured by utilizing the color change reaction of the test specimen and observing the color change thereof, any power or electric supply is not necessary at all.

In this case, since the bottom surface with opening is contacted with the inspection object, and the inside of the casing is shielded from the external air, even when the indoor air is contaminated with the organic substance, only the emission flux of the noxious substance released from the inspection object can be detected accurately not undergoing the effect thereof.

Further, since not an active method of transporting the object noxious substance to the test specimen by suction of air using power but by a passive method of transporting the noxious substance as far as the test specimen by molecule diffusion of the object noxious substance caused in the spontaneous state is utilized, the emission flux can be measured accurately in the usual state of use without disturbing the flowing state on the surface by measurement.

When a hollow case is formed by the low gas barrier property plastics etc., the permeation rate of the noxious substance can be kept lower by forming a DLC film on one or both of inner and outer surfaces of the casing for such substance.

Further, while the sampler may be of any size, in a case of using a square sample of about 5 mm to 1 cm in for length and the width, it may suffice that the outer profile size of the hollow casing is utmost about: length×width×thickness=2 cm×2 cm×3 cm and it can be simply bonded and fixed even to any narrow portion by using a double-sided pressure sensitive adhesive tape or the like.

Further, since the individual sampler is extremely simple in the structure and the manufacturing cost therefor is inexpensive as well, emission fluxes can be measured simultaneously by bonding and fixing a plurality of samplers to respective measuring sites.

It is not restricted to a case of measuring the emission flux by comparing the color of the test specimen with the color chart after lapse of a predetermined time but also measurement can be made more accurately by optically measuring the color of the test specimen and conducting calculation based thereon.

In this case, when the flux sampler put to reaction for a predetermined time is set to the setting stage formed in the light shielding chamber of the measuring apparatus, the measuring light irradiated from the light source is irradiated to the observing section, and the intensity of the reflection light is detected by the optical sensor.

The intensity of the reflection light corresponds to the color of the test specimen and the color of the test specimen corresponds to the emission flux.

Accordingly, by previously determining a relation between the emission flux and the intensity of the reflection light, the emission flux can be calculated accurately based on the intensity of the detected reflection light.

### Best Mode for Practicing the Invention

The present invention has attained the subject of enabling simple and accurate measurement for the flow rate of a chemical substance released from a site to be measured without undergoing the effect of external air (indoor air), by using a sampler of an extremely simple constitution without using an electric measuring apparatus.

The present invention is to be described specifically by way of a preferred embodiment for practicing the invention with reference to the drawings

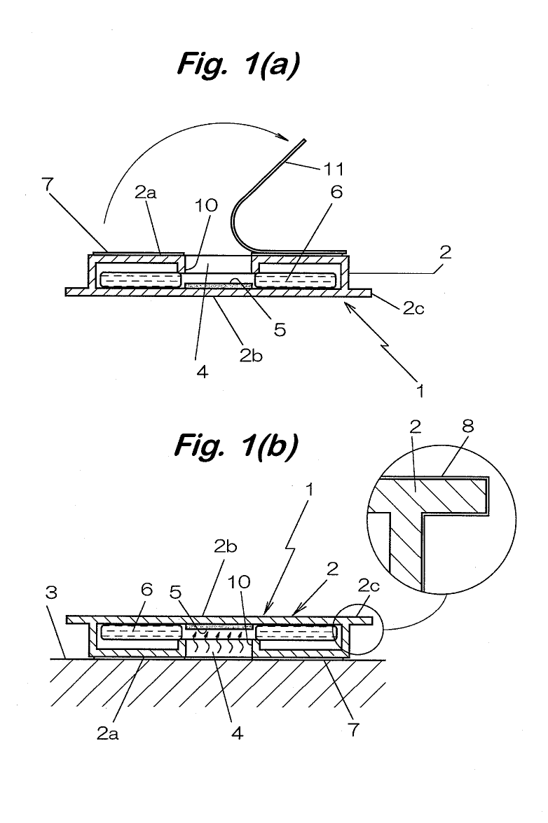

FIG. 1(a) is a cross sectional view showing an example of a passive type emission flux sampler, which is prepared, according to the invention.

FIG. 1(b) is a cross sectional view showing an example of a passive type emission flux sampler, which is reacted, according to the invention.

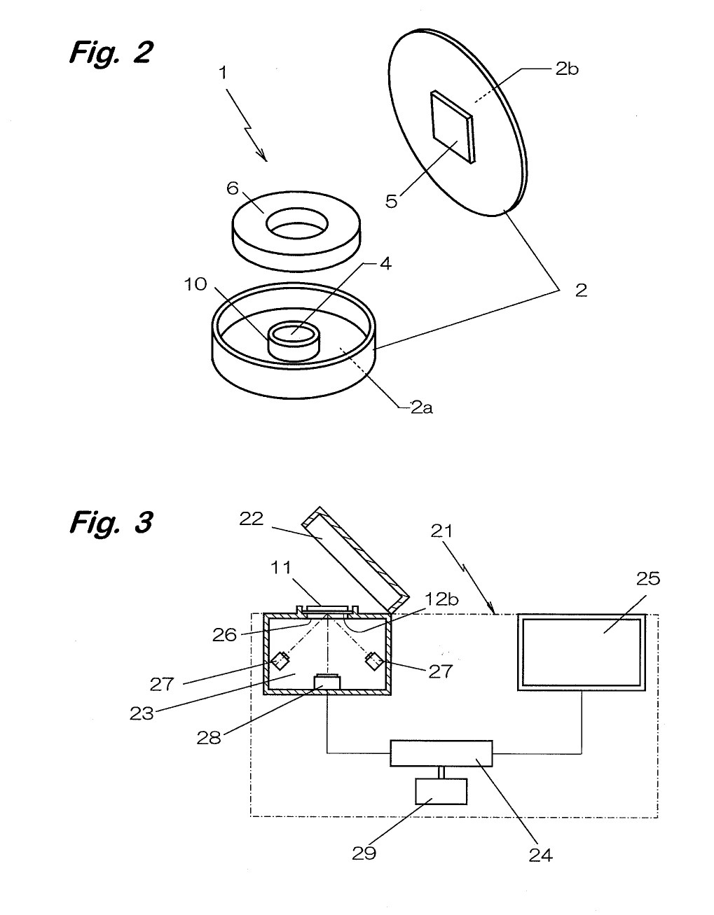

FIG. 2 is an exploded constitutional view thereof.

FIG. 3 is an explanatory view of a measuring apparatus for emission flux according to the invention.

FIG. 4 is an explanatory view showing an existent apparatus.

### Embodiment 1

A passive type emission flux sampler 1 of this embodiment is adapted to measure emission flux (released flow rate) in a casing where formaldehyde (chemical substance) contained in an inspection object 3 such as a building material is released in air, in which a disk-typed hollow flat casing 2 is sealed except an opening 4 that is formed at a bottom of casing 2a for taking in a chemical substance, a test specimen 5 that takes place color change reaction with the chemical substance under a humid circumstance is disposed to the inner surface of the casing 2 of an opposite side of the opening 4, and a water retaining material 6 for keeping the test specimen 5 in a humid circumstance is disposed in the hollow casing 2.

In the test specimen 5, INT (p-iodo-nitrotetrazolium violet) as a chromophoric agent and two types of enzymes dehydrogenase and diaphorase as a reaction catalyst are carried on a paper substrate sheet, for example, of about 1 cm×1 cm size.

Thus, when formaldehyde is in contact with the test specimen 5 wetted with water, hydrogen of formaldehyde is dissociated by the dehydrogenase and decomposed into formic acid and NADH (nicotinamide adenine dinucleotide) and NADH and INT are reacted by diaphorase to decrease INT and develop a color.

Further, a pressure-sensitive adhesive layer 7 such as a double-sided tape is disposed on the bottom surface 2a of the casing 2 so as not to cause a gap between the casing 2 and the inspection object 3, when the casing 2 is bonded and fixed to the surface of the inspection object 3.

Further, the hollow casing 2 is entirely formed transparent such that the color change of the test specimen 5 can be observed from the outside in a state of bonding to the inspection object 3 as it is, and the side opposite to the bottom surface 2a constitutes an observing section 2b for observing the test specimen 5 from the rear face, and a flange 2c is formed to the outer peripheral edge such that bonding and detachment can be conducted easily.

Since the test specimen 5 is disposed at inner surface of the observing section 2b, a distance from the opening 2a to the test specimen 5 can be kept constant. Thus, a distance from the surface of the inspection object 3 to the test specimen 5 can be kept constant in a state of bonding the flux sampler 1 to the inspection object 3.

In the casing 2, an annular water retaining paper (water retaining material) 6 is disposed so as to surround a flow channel from the opening 4 to the test specimen 5, which sucks a water droplet upon dripping the water droplet from the opening 4 into the casing 2 during measurement to keep the test specimen 5 in a humid circumstance.

Further, an annular rib 10 extends from the end edge of the opening 4 to the inside of the casing 2, by which the water droplet dripped from the opening 4 is guided with no stagnation by the surface tension of the water droplet to the water retaining paper 6 and guides the chemical substance released from the inspection object 3 straight to the test specimen 5 disposed being opposed to the opening 4 and causes the color change reaction more accurately in accordance with the released amount thereof.

In this embodiment, the hollow casing 12 is made of a plastic material of about 0.5 mm thickness to about: diameter×thickness=2 cm×3 mm and a diameter of opening 14 of about 5 mm.

In a case of using the plastic casing 12 of such a thickness, since formaldehyde permeates the plastic, a gas barrier film 8 such as a transparent DLC film (diamond like carbon film) or vapor deposited silica film is vapor deposited at least on one of the outer surface or the inner surface of the casing 12 in order to enhance the gas barrier property against formaldehyde. A DLC film is formed in this embodiment.

Since the DLC film has an extremely high gas barrier property to formaldehyde, formaldehyde contained in air in the room does not permeate the casing 12 and discolor the test specimen 15 but only the emission flux of formaldehyde released from the inspection object 13 can be measured accurately.

For the hollow casing 12, any material can be used such as glass or the like not being restricted to the plastic material and, in a case of using glass and, since the gas barrier property is high by nature, it is not necessary to form a gas barrier film.

Then, an annular adhesive layer 7 is formed at the periphery of the opening 4 at the bottom surface 2a of the hollow casing 2, and a circular aluminum sheet 11 is bonded to the adhesive layer 7 to air tightly seal the opening 4 so that moisture does not intrude into the casing 2 in a preserved state.

A constitutional example of the invention is as has been described above and the operation thereof is to be described.

In a case of measurement by using the flux sampler 1, the aluminum sheet 11 is peeled, a water droplet is dripped from the opening 4 into the casing 2 to moisten the test specimen 5, and a water retaining paper 6 is wetted so as to maintain the test specimen 5 in a humid circumstance during measurement.

In this case, since the annular rib 10 is formed to the opening 4, the water droplet flows smoothly into the casing 2 without staying at the end edge of the opening 4 by the surface tension of the water droplet.

Then, the opening 4 is directed to the inspection object 3, and the bottom surface 2a of the casing 2 is bonded to any inspection object 3 such as a wall surface, floor surface, ceiling surface, or furniture.

In this case, even when it is bonded with the opening 4 being downward, since the water droplet in the casing 2 is dammed by the annular rib 10 formed to the opening 4, it does not flow out from the opening 4.

In this state, the chemical substance released from the inspection object 3 passes through the opening 4 and is taken into the casing 2, guided along the flow channel formed with the annular rib 10 and reaches the test specimen 5 disposed in front thereof.

Then, after lapse of a predetermined time (30 min to 2 hours), the test specimen 5 turns to deep red color in a place where the amount of the emission flux is large and turns to pale red color in a place where it is small, and scarcely changes in a place where it is nearly equal to 0.

Accordingly, the emission flux can be measured in accordance with the color of the test specimen 5 in the same manner as described above.

Since the color of the test specimen 5 changes as described above, by comparison with a color chart previously prepared in accordance with the emission flux for the color after lapse of a predetermined time, emission flux of a noxious substance from the inspection site for the inspection object 3 can be measured.

Further, for an identical material, since it can be estimated that the amount of the emission flux from other portions is also identical, a total amount of release can be calculated based on the ratio between the area of the opening 4 and the surface area of the inspection object 3.

In this case, since the emission flux is measured by observing the color change utilizing the color change reaction of the test specimen 5, an inhalation of air is not necessary, and neither power nor electric power supply is not necessary at all upon measurement.

Further, since the noxious substance as an object is transported by molecule diffusion as far as the test specimen 5, emission flux can be measured accurately in a usual state of use without disturbing the flowing state on the surface of the measuring site by measurement.

Since the casing 2 has the DLC film 8 formed on one or both of the outer surface and the inner surface thereof and has a high gas barrier property against formaldehyde, formaldehyde contained in air in the room does not permeate the casing 2 and discolor the test specimen 5 but the emission flux of formaldehyde released from the inspection object 3 can be measured accurately.

Further, since the sampler 1 can be formed in an extremely small size as described above, it can be simply bonded and fixed to any narrow place by using, for example, a pressure sensitive adhesive tape.

Further, since the individual sampler 1 has an extremely simple structure and the production cost thereof is inexpensive, emission fluxes at a number of measuring sites can be measured simultaneously by bonding and fixing a plurality of samplers 1 to respective measuring places.

Of course in the present invention, not only the flux sampler 1 is fixed by the adhesive layer 7 which is formed to the periphery of the opening 4 as mentioned above, but also the flux sampler 1 can be fixed to the inspection object 3 by the transparent adhesive tape covered over itself, and further it can be fixed by arbitrary methods.

FIG. 3 is a measuring apparatus of emission flux for calculating the emission flux according to the invention.

A measuring apparatus 21 of this embodiment is adapted to measure the emission flux by using a flux sampler 1 described previously, in which a light shielding chamber 23 is formed to the inside of a light shielding cap 22 for optically measuring the color change of a test specimen 5 and includes a calculation processing device 24 for calculating the emission flux based on the detected color change and a liquid crystal display 25 for displaying the value thereof.

In the light shielding chamber 23, are disposed a setting stage 26 for positioning the flux sampler 1, a light source 27 for irradiating a measuring light to the observing section 2b of the flux sampler 1, and an optical sensor 28 for detecting the intensity of reflection light from the observing section 2b of the flux sampler 1.

When the flux sampler 1 is set to the setting stage 26 with the observing section 2b being downwarded, a measuring light is irradiated from the light source 27 disposed below the setting stage 26 to the position for the test specimen 5.

Since the test specimen 5 reacts with formaldehyde to discolor to red to red and purple color, the light source 27 uses an LED that outputs, as a measuring light, a green light in a complementary color relation therewith, and the center wavelength of the measuring light is selected to 555 nm in this embodiment.

A photodiode having a peak sensitivity at a wavelength of 500 to 600 nm is used as the optical sensor 28. In a case where the amount of emission flux of formaldehyde is large, since the test specimen 5 changes to a deep color to absorb the measuring light, the intensity of the reflection light detected by the optical sensor 28 is lowered whereas, in a case where the amount of the emission flux is small, since the test specimen 5 is less discolored and absorbs less measuring light, the intensity of the reflection light increases relatively.

The calculation processing apparatus 24 calculates the degree of absorption along with discoloration based on the intensity of the reflection light to calculate the amount of release based on the degree of light absorption.

At first, the light absorption degree P is calculated according to the following equation:
P=[1−V₁/V₀]×100 (%)

V₀ : intensity of reflection light of the test specimen 5 before reaction, or standard white light.

V₁ : intensity of reflection light for the test specimen 5 after reaction.

Then, a relation between the amount of released Fn and the light absorption degree Pn is stored based on the light absorption degree Pn of the sampler 1 measured by a known standard released amount Fn in a light absorption degree-released amount translation table 29, and the released amount F is determined with reference to the light absorption degree-released amount translation table 29 based on the light absorption degree P calculated for the flux sampler 1 after the reaction.

The light absorption degree-released amount translation table 29 may be in a state where it is represented by a function: Fn=f(Pn) or in a state of tabulating where the translated values and storing them.

With such a constitution, since the released amount P can be outputted as a numerical value, the released amount can be calculated accurately for a subtle color change of the test specimen 5 even in a case where comparison with the color chart is difficult.

While description has been made to a case where a transparent observing section 2b is formed to the casing 2, the invention is not restricted only thereto but it may be not transparent. In this case, when it is measured optically by using the measuring apparatus 21, a measuring light may be irradiated to the test specimen 5 on the side of the opening 4.

### INDUSTRIAL APPLICABILITY

As has been described above, the present invention is applicable to the measurement of emission flux of formaldehyde, as well as the invention is not restricted only thereto but applicable to an application use of measuring emission flux of other chemical substances such as volatile organic compounds (VOC) by optionally selecting a reagent to be impregnated into the test specimen.

### BRIEF DESCRIPTION OF THE DRAWINGS

[FIG. 1] is an explanatory view of a passive type emission flux sampler according to the invention.

[FIG. 2] is an exploded constitutional view thereof.

[FIG. 3] is an explanatory view of a measuring apparatus for emission flux according to the invention.

[FIG. 4] is an explanatory view showing an existent apparatus.

### DESCRIPTION FOR REFERENCES

1 passive type emission flux sampler
2 casing
2a bottom surface
2b observing section
3 inspection object
4 opening
5 test specimen
6 water retaining material
7 pressure sensitive adhesive layer
8 DLC film
10 annular rib

What is claimed is:

1.) A passive type emission flux sampler for measuring an emission flux of a specified chemical sample released from an inspection object, comprising:
a hollow casing sealed except for an opening formed at a bottom for taking in a chemical substance,
a test specimen that changes color in a reaction with the chemical substance and that is disposed to an inner surface of the casing opposite the opening, and
a water retaining material disposed in the hollow casing for maintaining the test specimen in a humid condition.

2.) A passive type emission flux sampler according to claim 1,
wherein the casing comprises a transparent observing section for observing the color change of the test specimen from the outside.

3.) A passive type emission flux sampler according to claim 1,
wherein the casing has a gas barrier property.

4.) A passive type emission flux sampler according to claim 1,
wherein a gas barrier film is formed to at least one of the inner surface and an outer surface of the casing to provide the casing with a gas barrier property.

5.) A passive type emission flux sampler according to claim 1, further comprising:
an annular rib extending from an end edge of the opening to inside the casing.

6.) A passive type emission flux sampler according to claim 1,
wherein a flange is formed to an outer peripheral edge of the casing.

7.) A passive type emission flux sampler according to claim 1,
wherein an aluminum sheet is configured to bond to the bottom surface of casing to seal the opening.
